(19) United States
(12) Patent Application Publication
(10) Pub. No.: US 2025/0172338 A1
(43) Pub. Date: May 29, 2025

(54) HYBRID RECYCLING FURNACE USING IMMERSION MELTING EQUIPMENT

(71) Applicant: Tesla, Inc., Austin, TX (US)

(72) Inventor: Jan Steglich, Berlin (DE)

(21) Appl. No.: 18/958,596

(22) Filed: Nov. 25, 2024

Related U.S. Application Data
(60) Provisional application No. 63/603,424, filed on Nov. 28, 2023.

(51) Int. Cl. F27B 3/20; C22B 21/00; F27D 3/14; F27D 27/00; F27D 99/00

(52) U.S. Cl. CPC F27B 3/20; F27D 3/14; F27D 27/005; F27D 99/0006; C22B 21/0092; F27D 2099/0013

(57) ABSTRACT

Examples of the present disclosure relate to a recycling furnace that may include a heating chamber configured to receive solid metal and an immersion heating unit adjacent to the heating chamber. The solid metal may undergo a thermolysis pre-treatment in the heating chamber, and the heating chamber may include a furnace that is configured to create liquid metal by melting the solid metal after the thermolysis pre-treatment. The immersion heating unit is configured to receive and heat the liquid metal, and each immersion heater is immersed in liquid metal.

### CLAIM OF PRIORITY

This application claims the benefit of priority to U.S. Provisional Patent Application Ser. No. 63/603,424 to Steglich et al. entitled “A HYBRID RECYCLING FURNACE USING IMMERSION MELTING EQUIPMENT,” filed Nov. 28, 2023, the disclosure of which is incorporated herein in its entirety by reference.

### BACKGROUND OF THE DISCLOSURE

Multi chamber furnaces with natural gas heating are commonly used to recycle various types of metal, such as aluminum and post-consumer aluminum scrap. Such post-consumer scrap contains organic contamination like coating, plastic sealings, lacquering, and other hydrocarbons. To remove this contamination, various processes such as thermolysis pre-treatment prior to melting and post combustion techniques of the generated thermolysis gases are used to control emissions. However, these recycling furnaces are solely gas-fired and therefore have limited efficiency and consume only fossil fuels.

### SUMMARY OF THE DISCLOSURE

According to one aspect of the present disclosure, a recycling furnace may include a heating chamber configured to receive solid metal, the solid metal undergoing a thermolysis pre-treatment in the heating chamber, wherein the heating chamber may include a furnace configured to create liquid metal by melting the solid metal after the thermolysis pre-treatment; and an immersion heating unit adjacent to the heating chamber that may include a plurality of immersion heaters, the immersion heating unit configured to receive and heat the liquid metal, wherein each immersion heater is immersed in liquid metal.

In some aspects, the plurality of immersion heaters may be arranged in a honeycomb configuration. In some aspects, the honeycomb configuration may include five rows of immersion heaters. In some aspects, each of the plurality of immersion heaters has a diameter of between 55 and 135 mm; and the plurality of immersion heaters has a heating power of between 1000 and 3000 kilowatts. In some aspects, the recycling furnace may include a recirculation pump configured to circulate the solid metal and the liquid metal. In some aspects, the immersion heating unit may include a pump for pumping the heated liquid metal to the heating chamber. In some aspects, the pump circulates the liquid metal to a side well within the heating chamber.

In some aspects, the plurality of immersion heaters may be removable from the immersion heating unit and the immersion heating unit may include a skimming ramp to receive a furnace tending machine. In some aspects, the recycling furnace may include a melting chamber configured to receive the solid metal, the heating chamber receiving the solid metal from the melting chamber by pulling the solid metal from the melting chamber. In some aspects, the immersion heating unit may include a pump for pumping the heated liquid metal to the melting chamber. In some aspects, the liquid metal moves at a speed of 0.1 m/s through the immersion heater. In some aspects, the immersion heating unit may include a pit to drain the liquid metal when emptying the furnace into a mold.

According to another aspect of the present disclosure, a method of operating a recycling furnace may include receiving, by a heating chamber, solid metal; applying, in the heating chamber, a thermolysis pre-treatment to the solid metal; melting, in the heating chamber and via a furnace, the solid metal to create liquid metal; circulating the liquid metal to an immersion heating unit adjacent to the heating chamber wherein the immersion heating unit comprises a plurality of immersion heaters; and heating the liquid metal via the plurality of immersion heaters, each immersion heater immersed in the liquid metal.

In some aspects, heating the liquid metal via the plurality of immersion heaters comprises heating the liquid metal via the plurality of immersion heaters arranged in a honeycomb configuration. In some aspects, the honeycomb configuration may include five rows of immersion heaters. In some aspects, each of the plurality of immersion heaters has a diameter of between 55 and 135 mm; and the plurality of immersion heaters has a heating power of between 1000 and 3000 kilowatts. In some aspects, the method may include pumping the heated liquid metal to the heating chamber via a pump of the immersion heating unit. In some aspects, the method may include circulating the liquid metal to a side well within the heating chamber. In some aspects, the method may include removing the plurality of immersion heaters from the immersion heating unit, the immersion heating unit comprising a skimming ramp; and receiving a furnace tending machine via the skimming ramp. In some aspects, the method may include circulating the liquid metal to a pit within the immersion heating unit to drain the liquid metal when emptying the furnace into a mold.

### BRIEF DESCRIPTION OF THE FIGURES

Various objectives, features, and advantages of the disclosed subject matter may be more fully appreciated with reference to the following detailed description of the disclosed subject matter when considered in connection with the following drawings, in which like reference numerals identify like elements.

FIG. 1 is an example hybrid twin chamber recycling furnace using immersion heating equipment according to some examples of the present disclosure.

FIG. 2 is an example hybrid single chamber recycling furnace using immersion heating equipment according to some examples of the present disclosure.

FIG. 3 is an example hybrid recycling furnace using immersion heating equipment with shaft furnace arrangement according to some examples of the present disclosure.

FIG. 4 is a cross section of an example arrangement of immersion heating units according to some examples of the present disclosure.

FIG. 5 is a top view explaining the use of different lids and an example shape of the side well according to some examples of the present disclosure.

FIG. 6 is an example method for operating a hybrid recycling furnace using immersion heating equipment according to some examples of the present disclosure.

FIG. 7 is a reference arrangement of the immersion heaters and a flow and efficiency optimized honeycomb shape according to some examples of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely illustrative in nature and is not intended to limit the disclosure or the applications of its use.

As discussed above, the efficiency of gas-fired recycling furnaces, especially for aluminum scrap metal, may be improved. Moreover, their consumption of fossil fuels of these recycling furnaces is unnecessarily high. Therefore, there is room for reducing CO₂ emissions as well as other emissions from recycling furnaces. According to various aspects of the present disclosure, a hybrid recycling furnace may be used to combine immersion heating equipment with natural gas heated recycling furnaces to reduce the fossil fuel consumption and allow for the decarbonization of aluminum production. Accordingly, aspects of the present disclosure relate to a hybrid recycling furnace that uses immersion heating equipment in addition to gas-fired burners to melt consumer metal, such as aluminum scrap metal. For example, the disclosed aspects apply immersion-based heating units, which may also by referred to herein as immersion-based melting units, to various configurations of gas-fired furnaces, such as single chamber, multi-chamber, and shaft arrangement furnaces. In other words, the disclosed immersion heating system may be retrofitted to various existing gas-fired furnaces. In some aspects, the disclosed immersion heating unit may be connected adjacently to an existing gas-fired furnace to contribute to melting and heating of liquid metal. The adjacent connection may include arranging the immersion heating unit to be positioned after or downstream of the furnace's main chamber. An immersion heating unit may include one or a plurality of immersion heaters that directly heat up material by being immersed in said material. For example, the immersion heating unit may be filled with liquid metal that has been melted by the gas furnace. The plurality of immersion heaters may then be submerged in the liquid metal, transferring heat directly to the metal in a particularly efficient manner and heating up the metal so that it may be used for various desirable applications.

The disclosed hybrid recycling furnace with immersion heating equipment may provide various benefits over prior iterations of metal recycling systems. For example, the disclosed examples may reduce fossil fuel consumption, and therefore carbon emissions, by between about 50-80%, about 40-70%, less than, equal to, or greater than about 50%, 55, 60, 65, 70, 75, or about 80%. Because of the efficiency in which immersion heaters may transfer heat to the material in which they are submerged in, the applied megawatts (MW) of the furnace itself may be significantly reduced. In some cases, where a typical gas-fired recycling furnace would require 11-12 MW of output, the disclosed system may replace 9-10 MW of the gas burners with a 2-3 MW immersion heating unit. Such a replacement may allow for carbon emissions to therefore be reduced as described herein above. Moreover, the disclosed furnace may allow for thermolysis and post-combustion treatments to be applied without prior de-coating or additional furnaces, as well as easier maintenance, cleaning, and cost, which may allow for a more continuous industrial scale operation.

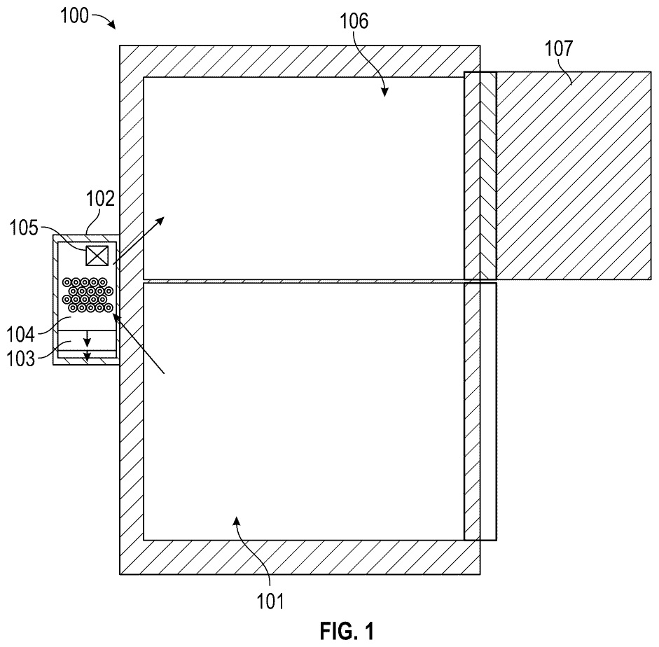

FIG. 1 is an example hybrid twin chamber recycling furnace 100 using immersion heating equipment according to some aspects of the present disclosure. The furnace 100 may include a heating chamber 101, an immersion heating unit 102, and a melting chamber 106. The “twin chamber” may refer to the existence of the two separate chambers: the heating chamber 101 and the melting chamber 106. Each of the chambers, such as the heating chamber 101 and the melting chamber 106, may be surrounded by refractory walls. A refractory wall may refer to a material that is generally resistant to decomposition by heat, pressure, and other extreme conditions. Moreover, the walls may retain their form and strength even when exposed to such extreme conditions, such as those present at the inside of a furnace. In addition, the furnace 100 may also include a loading area 107, where ingots, or other shapes, of solid metal may be loaded into the system.

After solid metal is loaded into the furnace 100 via the loading area 107, it may be moved into the melting chamber 106. For example, this may occur via various mechanisms such as ramps, moving walkways, vibro feeders, or the like. Once the cold/solid metal is within the melting chamber 106, the pump 105 circulates the hot metal from the heating chamber 101 through the immersion heaters 104 to the melting chamber 106. In some examples, the heating chamber 101 may include one or more gas burners, which may be configured to apply heat to the solid metal to cause it to melt. In some examples, the gas burner may be a burner with a capacity of three MW or less that burns natural gas, biogas, or H₂, although these are not required. In some aspects, the heating chamber 101 may be further configured to, prior to melting the solid metal via the gas burners, apply a thermolysis treatment to the solid metal. In some aspects, thermolysis treatments may involve decomposing various materials with heat and without the presence of oxygen. Example materials that may be decomposed may include the contaminations discussed hereinabove that may be included with post-consumer scrap metal. In some aspects, other thermochemical conversions may be applied. After the thermolysis, various non-metal materials may be recovered and removed. Additionally, the heating chamber 101 may be configured to apply post-combustion techniques to the metal. For example, the thermolysis gases from the organic contamination may be post-combusted to increase energy efficiency and control emissions.

In some examples, the immersion heating unit 102 may include a skim ramp 103, one or a plurality of immersion heaters 104, and a pump 105. In some examples, the skim ramp 103 allows for a furnace tending machine to enter the immersion heating unit 102 for cleaning of the immersion heaters 104. In some examples, the plurality of immersion heaters 104 may be arranged in a honeycomb or frog spawn configuration. For example, such a configuration may include four rows or lines of immersion heaters, and each row may have an equal number of heaters. In some examples, there may be thirty-six immersion heaters arranged in four rows of nine, so that the liquid metal subsequently flows through each of the four rows. In some examples, each immersion heater may have a height of about 600-1200 mm, about 700-1100 mm, 800-1000 mm, less than, equal to, or greater than about 600 mm, 650, 700, 750, 800, 850, 900, 950, 1000, 1050, or about 1100 mm. A diameter of each immersion heater may range from about 55-115 mm, about 60-110, about 80-100, less than, equal to, or greater than about 55 mm, 60, 65, 70, 75, 80, 85, 90, 95, 100, 105, or about 110 mm. A heater surface of each immersion heater may range from about 1500-3300 cm² per element, about 1600-3000 cm² per element, about 2000-2500 cm² per element, less than, equal to, or greater than about 1500 cm² per element, 1600, 1700, 1800, 1900, 2000, 2100, 2200, 2300, 2400, 2500, 2600, 2700, 2800, 2900, or about 3000 cm² per element. A heating power of each immersion heater may range from about 50-110 KW, about 60-100 kW, about 70-90 kW, less than, equal to, or greater than about 50 kW, 55, 60, 65, 70, 75, 80, 85, 90, 95, 100, or about 100 KW. Moreover, the total heating power of the plurality of immersion heaters 104 may be about 2500 kW, depending on the desired application. In addition, while thirty-six heaters may be used, any number may be used, For example, the immersion heating unit 102 may include, about 20-50 immersion heaters 104, about 25-45 immersion heaters 104, about 30-40 immersion heaters 104, less than, equal to, or greater than about 25, 26, 27, 28, 29, 30, 31, 32, 33, 34, 35, 36, 37, 38, 39, 40, 41, 42, 43, 44, 45, 46, 47, 48, 49, or 50 immersion heaters 104. Additional examples of parameters are shown below in Table 1.

TABLE 1

| Parameter | Value | Unit |
|---|---|---|
| Height of heating zone | 0.9 | m |
| Distance between heaters | 0.3 | m |
| Shape factor | 1:2 | — |
| Number of immersion heaters | 36 | |
| Arrangement width | 8 | Heaters |
| Arrangement length | 5 | Heaters |
| Arrangement width | 2.4 | m |
| Arrangement length | 1.5 | m |
| Arrangement volume | 3.24 | m³ |
| Density of liquid alloy | 2.35 | t/m³ |
| Arrangement metal content | 7.6 | t |
| Minimum flow | 0.1 | m/s |
| Melt flow time | 15 | S |
| Specific flow | 0.51 | t/s |
| Specific flow | 30 | t/min |

After the metal mixture has been reheated by the immersion heaters 104, the pump 105 may pump the heated metal mixture out of the immersion heating unit 102 and back into the melting chamber 106. The pump 105 may be a mechanical or an inductive metal pump.

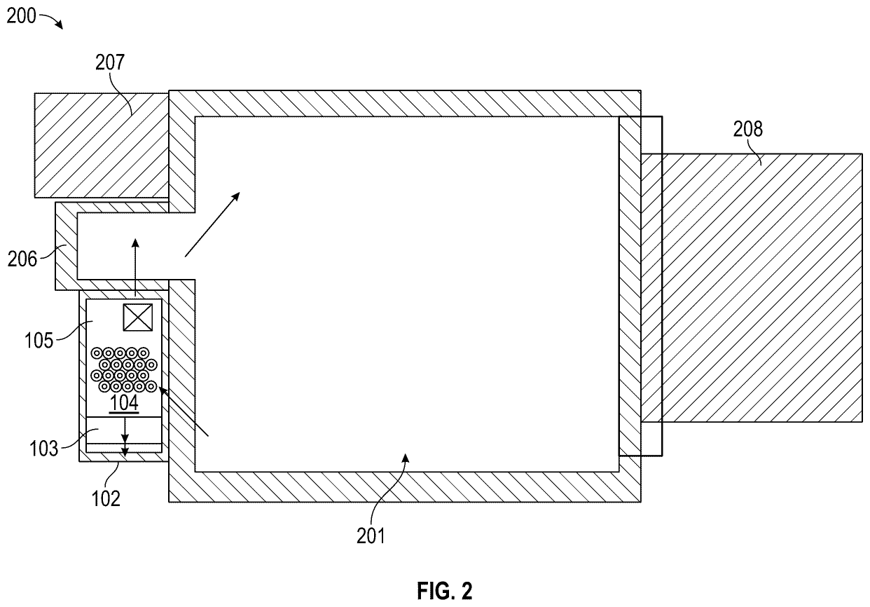

FIG. 2 shows an example hybrid single chamber recycling furnace 200 using immersion heating equipment according to some examples of the present disclosure. The furnace 200 may include a heating chamber 201, which may have similar capabilities to the heating chamber 101 of furnace 100. The heating chamber 201, which may also be referred to as a melting chamber 201, may receive solid metal from a loading area 208, and this may be in a manner similar to how the solid metal is received in furnace 100. In addition, the heating chamber 201 may be configured to apply thermolysis treatments to the received solid metal, and the removed materials, such as consumer contaminations and the like, may be recovered from the system. Next, the heating chamber 201 may utilize its burners to melt the solid metal, which may then transferred and/or circulated to the immersion heating unit 102. In some examples, the heating unit 102 may be the same as or similar to the heating unit 102 of FIG. 1. The liquid metal may then flow through the immersion heater 104 and is heated thereby.

After the metal mixture has been heated by the immersion heaters 104, the pump 105 may pump the heated metal mixture out of the immersion heating unit 102 and into a side well 206 of the heating chamber 201. The pump 105 may be a mechanical or an inductive metal pump. In some examples, a second loading area 207 may be used as open side well to continuously charge scrap without contamination.

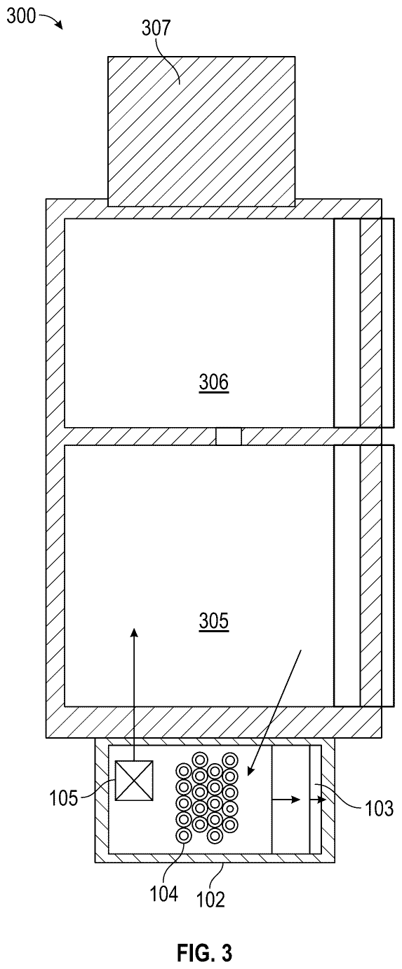

FIG. 3 is an example hybrid recycling furnace 300 using immersion heating equipment with shaft furnace arrangement according to some examples of the present disclosure. The furnace 300 may include a heating chamber 305, a melting chamber 306, a loading area 307, and an immersion heating unit 102. In some examples, the heating unit 102 may be the same as or similar to the heating unit 102 of FIGS. 1 and 2, demonstrating the flexibility of the disclosed immersion heater and its applicability with numerous types of furnace arrangements. The furnace 300 may be configured in a shaft arrangement, where solid metal may be loaded via the loading area 307. The solid metal may then fall vertically through the melting chamber 306, which opens into a top section of the heating chamber 305.

Once the heating chamber 305 receives solid metal via the melting chamber 306, the heating chamber 305 may perform various processes similar to those described in FIGS. 1 and 2. For example, the heating chamber 305 may be configured to apply thermolysis treatments to the received solid metal, and the removed materials, such as consumer contaminations and the like, may be recovered from the system. Next, the heating chamber 305 may utilize its burners to melt the solid metal, which may then be transferred and/or circulated to the immersion heating unit 102. The liquid metal may then flow through the configuration of the immersion heater 104 and may be heated thereby. After the metal mixture has been heated by the immersion heaters 104, the pump 105 may pump the heated metal mixture out of the immersion heating unit 102 and back into the heating chamber 305.

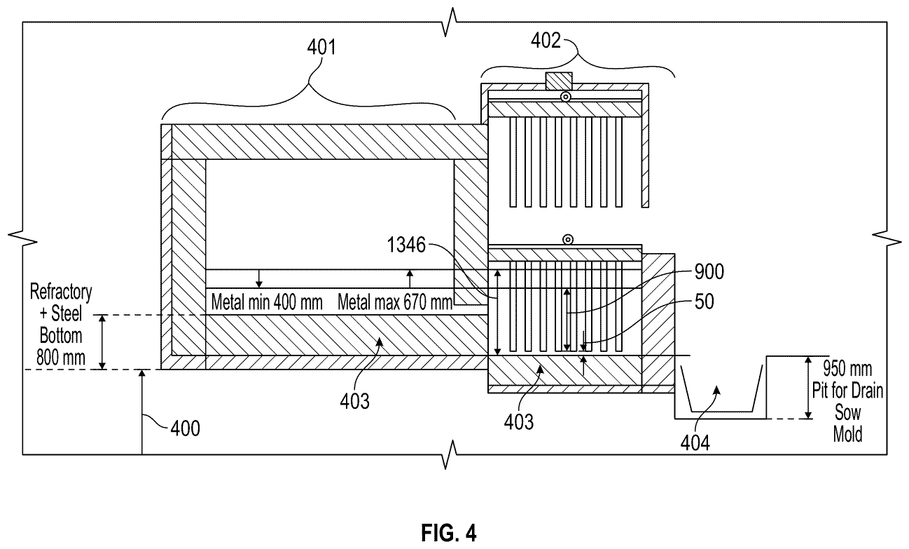

FIG. 4 is a cross section of an example arrangement of immersion heating units according to some examples of the present disclosure. The furnace illustrates a heating chamber 401 connected adjacently to an immersion heating unit 402, which may be the same as or similar to the immersion heating unit 102 of FIGS. 1-3. The furnace may include a loading area 400 which may be, for example, at a normal ground level. Further, the furnace may include various refractory walls 403 that surround the heating chamber 401 and the immersion heating unit 402. In some examples, the refractory walls 403, as well as the refractory walls generally referred to herein, may be made of steel. A thickness of the refractory walls 403 may range from about 500-1000 mm, about 600-900 mm, about 750-850 mm, less than, equal to, or greater than about 500 mm, 550, 600, 650, 700, 750, 800, 850, 900, 950, or about 1000 mm. In addition, as discussed herein above, the heating chamber 401 may include a gas burner to melt the solid metal that is received. In some examples, the heating chamber 401 may have a minimum metal level of about 200-600 mm, about 300-500 mm, about 350-450 mm, less than, equal to, or greater than about 200 mm, 250, 300, 350, 400, 450, 500, 550, or about 600 mm. A maximum metal level of the heating chamber 401 may be in a range of about 600-800 mm, about 650-700 mm, about 660-690 mm, less than, equal to, or greater than about 600 mm, 610, 620, 630, 640, 650, 660, 670, 680, 690, 700, 710, 720, 730, 740, 750, 760, 770, 780, 790, or about 800 mm. These above described dimensions are merely explanatory in nature and are not intended to be limiting.

In some examples, the immersion heaters of the immersion heating unit 402 may be maintained at a height of about 25-70 mm above the bottom of the unit, about 30-60 mm, about 40-50 mm, less than, equal to, or greater than about 25 mm, 30, 35, 40, 45, 50, 55, 60, 65, or about 70 mm. Moreover, the immersion heating unit 402 may have an inner height of about 1200-1400 mm, about 1250-13800, about 1320-1350 mm, less than, equal to, or greater than about 1200 mm, 1210, 1220, 1230, 1240, 1250, 1260, 1270, 1280, 1290, 1300, 1310, 1320, 1330, 1340, 1346, 1350, 1360, 1370, 1380, 1390, or about 1400 mm. The immersion heating unit 402 may maintain liquid metal during heating at a depth of about 700-1100 mm, about 800-1000 mm, about 850-950 mm, less than, equal to, or greater than about 700 mm, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, or about 1100 mm. FIG. 4 further illustrates the two positions, which the immersion heating unit 402 may conform to. The bottom shows the immersion heaters in a heating position, while the top shows when the immersion heaters have been removed from the system, such as for cleaning. Finally, the immersion heating unit 402 may include a pit 404 to drain the liquid metal when emptying the furnace into a mold at its lowest position, which may be used to drain the furnace.

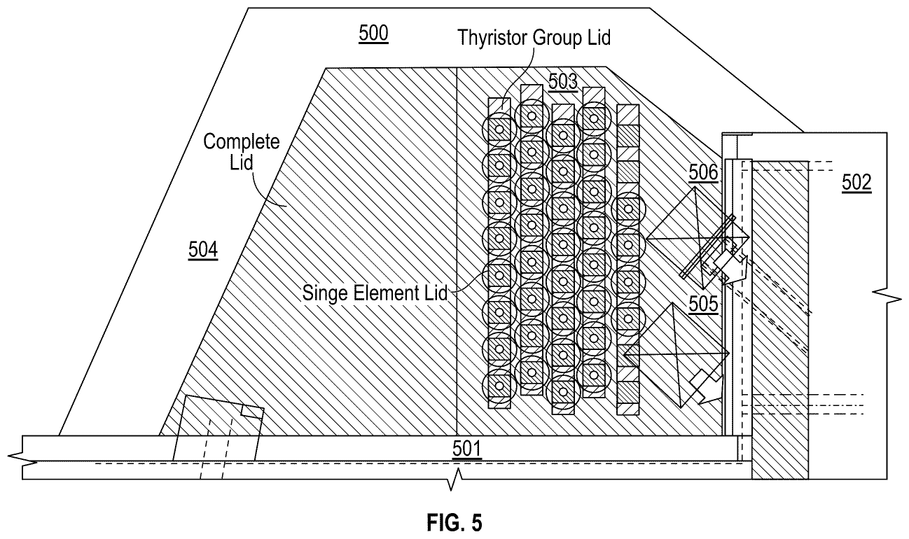

FIG. 5 is a top view of the immersion unit 500 and shows the use of different lids and an example shape of the side well according to some examples of the present disclosure. For example, FIG. 5 shows an immersion unit 500, which may be the same as or similar to the immersion heating unit 102 of FIGS. 1-3. The immersion heating unit 500 may be connected adjacent to a heating chamber 501, which may be the same as or similar to the heating chamber 201 of FIG. 2, and a side well 502, which may be the same as or similar to the side well 206 of FIG. 2.

The immersion heating unit 500 may include a skim ramp 504, which may allow for a furnace tending machine to enter and clean the immersion heating unit 500. Further, the immersion heating unit 500 may include a plurality of immersion heaters 503 that may be arranged in a honeycomb or frog spawn configuration. In some examples, one or more of the immersion heaters 503 may be removable from the immersion heating unit 500 to allow for additional cleaning. For example, all immersion heaters 503 may be removed simultaneously. In other examples, the arrangement may be configured such that groups are removable one at a time, for example eight at a time or individually. In some examples, the lid containing the plurality of immersion heaters 503 may include a thyristor group lid that enables specific groupings of immersion heaters 503 to be lifted and removed simultaneously while also disabling power, and thus heat, to those heaters. Further, by configuring the lid to include individual thyristors, individual heaters 503 may be disabled and removed, allowing for cleaning and/or maintenance to be performed while the rest of the system remains in operation.

In addition, the immersion heating unit 500 may include pumps 505 and 506, which may be, for example, mechanical or inductive metal pumps. In examples where the pumps 505 and 506 are mechanical pumps, they each may be operated with variable speeds, which may eliminate dead spots with no circulation of metal. The pumps 505 and 506 may pump liquid metal, after it has been heated by the submerged immersion heaters 503, into the side well 502.

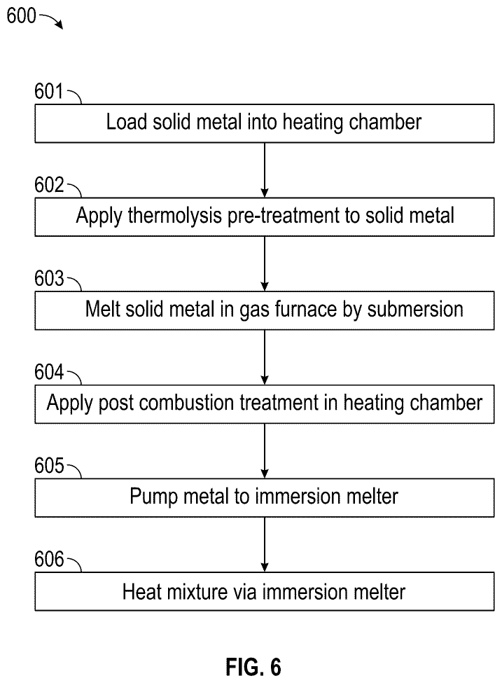

FIG. 6 is an example method 600 for operating a hybrid recycling furnace using immersion heating equipment according to some examples of the present disclosure. At block 601, a melting chamber is loaded with solid metal or aluminum scrap. The melting chamber of block 601 may be melting chamber 106, 201, or 306. For example, in the case of the twin chamber recycling furnace 100 of FIG. 1, the melting chamber 106 may be loaded with metal from the loading area 107. The molten metal may flow over to the heating chamber 101 and may be circulated by the metal pumps through the immersion heater. In the single chamber furnace 200 of FIG. 2, the melting chamber 201 may be loaded from the loading area 208 the metal superheated by the immersion heaters and the furnace atmosphere by the conventional natural gas burners. In the shaft arrangement furnace 300 of FIG. 3, the melting chamber 306 may receive the solid metal via the shaft, which may be molten in direct contact with liquid metal. The metal may then be superheated in the immersion heating unit 102 and circulated back into the melting chamber 306.

At block 602, the melting chamber may apply a thermolysis pre-treatment to the solid metal. In some examples, applying the thermolysis pre-treatment may include applying heat without oxygen to the solid metal to remove contaminants from the metal, which may then be recovered and removed from the system. At block 603, the melting chamber may melt the solid metal such that it is in a substantially liquid form in direct contact with the superheated melt from the immersion heaters. At block 604, the heating chamber post may combust the thermolysis gases from the scrap generated in the melting chamber. At block 605, the liquid metal may be pumped/circulated from the heating chamber to the adjacent immersion heating unit 102. In some examples, the liquid metal may be circulated at a flow speed between about 0.1-0.5 m/s, about 0.2-0.4 m/s, less than, equal to, or greater than about 0.1 m/s, 0.2, 0.3, 0.4, or about 0.5 m/s. At block 606, the immersion heaters, such as immersion heaters 104, contained within the immersion heating unit 102 heat the mixture or liquid metal. For example, the immersion heaters may be submerged within the liquid metal, applying heat directly to the mixture and causing the mixture to heat up.

After method 600 is completed, various additional steps may be taken, depending on the particular furnace arrangement. For example, in the furnace 100 of FIG. 1, the heated mixture may be pumped via pump 105 into the melting chamber 106. In the furnace 200 of FIG. 2, the heated mixture may be pumped via pump 105 back into the heating chamber 201. In the furnace 300 of FIG. 3, the heated mixture may be pumped via pump 105 back into the heating chamber 305.

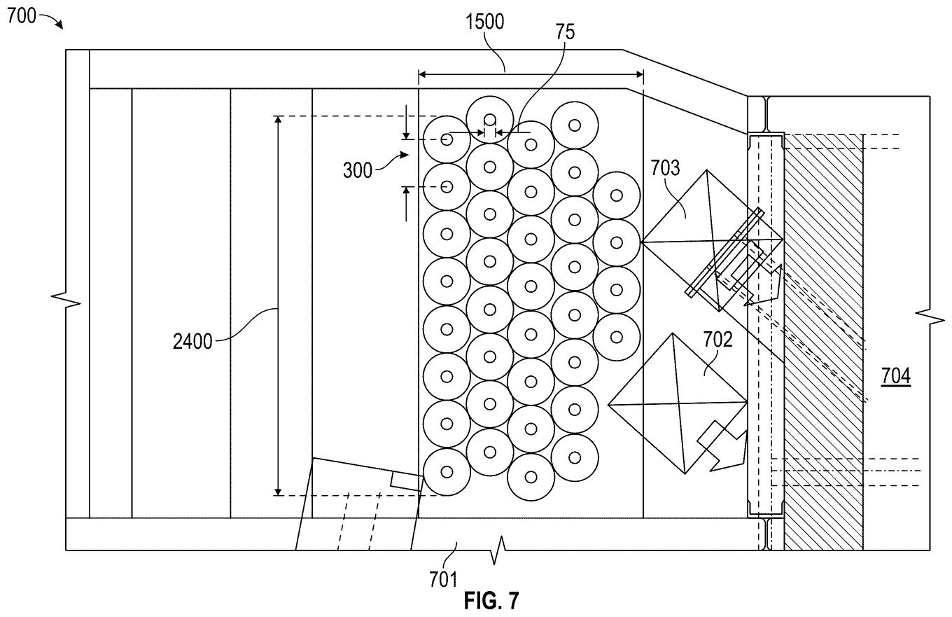

FIG. 7 is shows an arrangement 700 of the immersion heaters 701 and a flow and efficiency optimized honeycomb shape according to some examples of the present disclosure. In some examples, the arrangement 700 may include a plurality of immersion heaters 701 in a frogspawn or honeycomb configuration. Similar to previous examples discussed herein, the immersion heaters 701 may be configured to submerge within liquid metal that has been pumped in from a heating chamber and therefore heat up the liquid metal. In addition, the arrangement 700 may include pumps 702 and 703 that may be configured to pump the heated liquid metal from the immersion unit to a side well 704. Example dimensions and parameters for such an arrangement 700 are discussed below in Table 2.

TABLE 2

| | Immersion Heater Current | | 10 t/h Immersion | |
|---|---|---|---|---|
| Parameter | Tested Specification | | heating System | |
| Power per immersion | 30 | kW | 70 | kW |
| heater | | | | |
| Heating zone height | 460 | mm | 900 | mm |
| Heater diameter | 55 | mm | 75 | mm |
| Active heating surface | 795 | cm² | 2121 | cm² |
| Design heat flux (Q) | 38 | W/cm² | 33 | W/cm² |
| Number of installed | 12 | | 36 | |
| elements | | | | |
| Combined power of | 360 | kW | 2500 | kW |
| elements | | | | |

### Aspects.

Some examples herein include the following aspects, the numbering of which should not be construed as designating levels of importance.

Aspect 1 provides a recycling furnace comprising:
a heating chamber configured to receive solid metal, the solid metal undergoing a thermolysis pre-treatment in the heating chamber, wherein the heating chamber comprises a furnace configured to create liquid metal by melting the solid metal after the thermolysis pre-treatment; and
an immersion heating unit adjacent to the heating chamber and comprising a plurality of immersion heaters, the immersion heating unit configured to receive and reheat the liquid metal, wherein each immersion heater is immersed in liquid metal.

Aspect 2 provides the recycling furnace of Aspect 1, wherein the plurality of immersion heaters are arranged in a honeycomb configuration.

Aspect 3 provides the recycling furnace of Aspect 2, wherein the honeycomb configuration comprises five rows of immersion heaters.

Aspect 4 provides the recycling furnace of Aspect 1, wherein:
each of the plurality of immersion heaters has a diameter of in a range of from about 55 mm to about 135 mm; and
the plurality of immersion heaters has a heating power in a range of from about 1000 kilowatts to about 3000 kilowatts.

Aspect 5 provides the recycling furnace of Aspect 1, further comprising a recirculation pump configured to circulate the liquid metal.

Aspect 6 provides the recycling furnace of Aspect 1, wherein the immersion heating unit further comprises a pump for pumping reheated liquid metal back to the heating chamber after reheating.

Aspect 7 provides the recycling furnace of Aspect 6, wherein the pump circulates the reheated liquid metal to a side well within the heating chamber.

Aspect 8 provides the recycling furnace of Aspect 1, wherein the plurality of immersion heaters are removable from the immersion heating unit and the immersion heating unit further comprises a skimming ramp to receive a furnace tending machine.

Aspect 9 provides the recycling furnace of Aspect 1, wherein the recycling furnace further comprises a melting chamber configured to receive the solid metal, the heating chamber receiving the solid metal from the melting chamber by pulling the solid metal from the melting chamber.

Aspect 10 provides the recycling furnace of Aspect 9, wherein the immersion heating unit further comprises a pump for pumping heated liquid metal to the melting chamber.

Aspect 11 provides the recycling furnace of Aspect 5, wherein the liquid metal moves at a speed of about 0.1 m/s through the immersion heating unit.

Aspect 12 provides the recycling furnace of Aspect 1, wherein the immersion heating unit further comprises a pit to drain the liquid metal when emptying the furnace into a mold.

Aspect 13 provides a method of operating a recycling furnace comprising:
receiving, by a heating chamber, solid metal;
applying, in the heating chamber, a thermolysis pre-treatment to the solid metal;
melting, in the heating chamber and via a furnace, the solid metal to create liquid metal;
circulating the liquid metal to an immersion heating unit adjacent to the heating chamber wherein the immersion heating unit comprises a plurality of immersion heaters; and
reheating the liquid metal via the plurality of immersion heaters, each immersion heater immersed in the liquid metal.

Aspect 14 provides the method of Aspect 13, wherein heating the liquid metal via the plurality of immersion heaters comprises heating the liquid metal via the plurality of immersion heaters arranged in a honeycomb configuration.

Aspect 15 provides the method of Aspect 14, wherein the honeycomb configuration comprises five rows of immersion heaters.

Aspect 16 provides the method of Aspect 13, wherein:
each of the plurality of immersion heaters has a diameter of in a range of from about 55 mm to about 135 mm; and
the plurality of immersion heaters has a heating power in a range of from about 1000 kilowatts to about 3000 kilowatts.

Aspect 17 provides the method of Aspect 13, further comprising pumping reheated liquid metal back to the heating chamber via a pump of the immersion heating unit.

Aspect 18 provides the method of Aspect 17, further comprising circulating the reheated liquid metal to a side well within the heating chamber.

Aspect 19 provides the method of Aspect 17, further comprising:
removing the plurality of immersion heaters from the immersion heating unit, the immersion heating unit comprising a skimming ramp; and
receiving a furnace tending machine via the skimming ramp.

Aspect 20 provides the method of Aspect 14, further comprising circulating the liquid metal to a pit within the immersion heating unit to drain the liquid metal when emptying the furnace into a mold.

While various aspects and examples have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative aspects. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts may be carried out in any order without departing from the principles of the disclosure, except when a temporal or operational sequence is explicitly recited. Furthermore, specified acts may be carried out concurrently unless explicit claim language recites that they be carried out separately. For example, a claimed act of doing X and a claimed act of doing Y may be conducted simultaneously within a single operation, and the resulting process will fall within the literal scope of the claimed process.

The term “about” as used herein may allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein may mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “post-consumer” scrap may refer to material generated by households or by commercial, industrial, and institutional facilities in their role as end-users of a product which may no longer be used for its intended purpose.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A recycling furnace comprising:
a heating chamber configured to receive solid metal, the solid metal undergoing a thermolysis pre-treatment in the heating chamber, wherein the heating chamber comprises a furnace configured to create liquid metal by melting the solid metal after the thermolysis pre-treatment; and
an immersion heating unit adjacent to the heating chamber and comprising a plurality of immersion heaters, the immersion heating unit configured to receive and reheat the liquid metal, wherein each immersion heater is immersed in liquid metal.

2. The recycling furnace of claim 1, wherein the plurality of immersion heaters are arranged in a honeycomb configuration.

3. The recycling furnace of claim 2, wherein the honeycomb configuration comprises five rows of immersion heaters.

4. The recycling furnace of claim 1, wherein:
each of the plurality of immersion heaters has a diameter of in a range of from about 55 mm to about 135 mm; and
the plurality of immersion heaters has a heating power in a range of from about 1000 kilowatts to about 3000 kilowatts.

5. The recycling furnace of claim 1, further comprising a recirculation pump configured to circulate the liquid metal.

6. The recycling furnace of claim 1, wherein the immersion heating unit further comprises a pump for pumping reheated liquid metal back to the heating chamber after reheating.

7. The recycling furnace of claim 6, wherein the pump circulates the reheated liquid metal to a side well within the heating chamber.

8. The recycling furnace of claim 1, wherein the plurality of immersion heaters are removable from the immersion heating unit and the immersion heating unit further comprises a skimming ramp to receive a furnace tending machine.

9. The recycling furnace of claim 1, wherein the recycling furnace further comprises a melting chamber configured to receive the solid metal, the heating chamber receiving the solid metal from the melting chamber by pulling the solid metal from the melting chamber.

10. The recycling furnace of claim 9, wherein the immersion heating unit further comprises a pump for pumping heated liquid metal to the melting chamber.

11. The recycling furnace of claim 5, wherein the liquid metal moves at a speed of about 0.1 m/s through the immersion heating unit.

12. The recycling furnace of claim 1, wherein the immersion heating unit further comprises a pit to drain the liquid metal when emptying the furnace into a mold.

13. A method of operating a recycling furnace comprising:
receiving, by a heating chamber, solid metal;
applying, in the heating chamber, a thermolysis pre-treatment to the solid metal;
melting, in the heating chamber and via a furnace, the solid metal to create liquid metal;
circulating the liquid metal to an immersion heating unit adjacent to the heating chamber wherein the immersion heating unit comprises a plurality of immersion heaters; and
reheating the liquid metal via the plurality of immersion heaters, each immersion heater immersed in the liquid metal.

14. The method of claim 13, wherein heating the liquid metal via the plurality of immersion heaters comprises heating the liquid metal via the plurality of immersion heaters arranged in a honeycomb configuration.

15. The method of claim 14, wherein the honeycomb configuration comprises five rows of immersion heaters.

16. The method of claim 13, wherein:
each of the plurality of immersion heaters has a diameter of in a range of from about 55 mm to about 135 mm; and
the plurality of immersion heaters has a heating power in a range of from about 1000 kilowatts to about 3000 kilowatts.

17. The method of claim 13, further comprising pumping reheated liquid metal back to the heating chamber via a pump of the immersion heating unit.

18. The method of claim 17, further comprising circulating the reheated liquid metal to a side well within the heating chamber.

19. The method of claim 17, further comprising:
removing the plurality of immersion heaters from the immersion heating unit, the immersion heating unit comprising a skimming ramp; and
receiving a furnace tending machine via the skimming ramp.

20. The method of claim 14, further comprising circulating the liquid metal to a pit within the immersion heating unit to drain the liquid metal when emptying the furnace into a mold.
